(19) United States
(12) Patent Application Publication
(10) Pub. No.: US 2013/0316320 A1
(43) Pub. Date: Nov. 28, 2013

(54) Contextual Just in Time Learning System and Method

(71) Applicants: Martin Harwar, Warwickshire (GB); Amar Shah, Kolhapur (IN); Arpan Shah, Kirkland, WA (US)

(72) Inventors: Martin Harwar, Warwickshire (GB); Amar Shah, Kolhapur (IN); Arpan Shah, Kirkland, WA (US)

(73) Assignee: Point 8020 Limited, Warwickshire (GB)

(21) Appl. No.: 13/902,167

(22) Filed: May 24, 2013

Related U.S. Application Data
(60) Provisional application No. 61/651,233, filed on May 24, 2012.

(51) Int. Cl. G09B 5/06

(52) U.S. Cl. CPC G09B 5/065
USPC 434/309

(57) ABSTRACT

A system and method of presenting context-sensitive learning assets, such as videos or other files, in a user interface. The user interface components send an identifier of the context of a user interface to a learning platform, which is used to identify content descriptors for the appropriate learning assets. The content descriptors are sent back to the user interface, where the learning assets described by the content descriptors can be viewed by the user. The system and method uses one of three modes for creating content descriptors. In Static Mode, a unique identifier is sent from the user interface and the content descriptors that are identified by that identifier are returned. In Dynamic Metadata-Driven Mode, metadata is sent, and rules determine which content descriptors are returned. In Dynamic Content-Driven mode, the entire page content being viewed is analyzed and specific search algorithms determine which content descriptors are returned.

This utility patent application is based upon and claims the filing date benefit of U.S. provisional patent application (Application No. 61/651,233) filed on May 24, 2012.

### COPYRIGHT NOTICE

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

The present invention relates to websites or applications with a plurality of learning videos or information documents embedded or linked thereto, wherein the nature and content of the video or documents presented is based on the contextual information of the webpage being visited or application feature being used.

2. Description of the Related Art

It is common for websites to include embedded video files or hyperlinks to remote video files presenting ‘how to’ training information on various products and services discussed or sold on a website. Many companies hire learning administrators responsible for planning the website, determining what and how the information is presented to the user, whether a video file would be helpful, and whether the video file should be embedded into the website or linked to the website by a hyperlink. They are also responsible for updating the website with the most current videos and hyperlinks.

Today, users waste substantial time searching on the INTERNET for products, services, and general help information on a topic. This is especially true with software applications that are more complex and constantly upgraded. Learning administrators hired by application developers to provide help support, must determine whether help information on a topic would be helpful and what format should be used to present the information.

Some companies use support personnel who provide ‘live’ support by answering questions regarding a feature or functionality of a software program. Such ‘live’ support is very expensive and requires constant training. One way to reduce costs is to hire workers in different regions of the world with reduce labor costs. Unfortunately, many end users know that foreign labor costs are lower and resent being forced to discuss important support issues with less expensive foreign support personnel.

An alternative to providing ‘live’ support is to offer a library of short videos on a wide variety of topics that can be easily accessed by the end user or visitor. For example, a short video file or a simple document that can be easily accessed from a website that explains to an end user or visitor a feature of a service or product or how a problem is resolved would be very useful. Determining which short video or simple document to present to the end user or visitor is often limited by the structure of the webpage or by the keywords submitted into a search.

What is needed is a system and method in which videos and documents are automatically presented to the end users or visitors based on which website is being viewed or where in a software program help request in being submitted. What is also needed is a system or method that allows learning administrators to easily and quickly change the video files or documents when deemed necessary. Furthermore, what is needed is a system and method that allows learning administrators to target relevant video files and documents to users based on which webpage is being viewed or where in a software program the user requires help.

### SUMMARY OF THE INVENTION

Disclosed is a system and method of presenting context-sensitive learning assets, such as videos or other digital files, in the user interface. Components in the user interface send indicators of the user's current context to a learning platform, and they are used to identify content descriptors. The content descriptors are sent back to the user interface, where the learning assets described by the content descriptors can be immediately viewed by the user.

The system and method uses one of three modes for creating content descriptors. In a first mode, called a static mode, the user interface sends a unique identifier to the learning platform. The learning platform identifies the content descriptors associated with the unique identifier and then sends the content descriptors to the user interface. The video files or documents associated with the content descriptors are viewable immediately in the user interface.

In a second mode, called a Dynamic Metadata-Driven Mode, metadata values from the user interface are sent to the learning platform. Rules associated with the metadata are then used to determine the content descriptors then sent to the user interface. The video files or documents associated with the content descriptors are viewable immediately in the user interface.

In a third mode, called a Dynamic Content-Driven mode, the entire page content being viewed is analyzed and specific search algorithms determine which content descriptors are returned. In summary, the system and method disclosed gives learning administrators greater control over how video files or documents are selected and accessed by end users. Learning administrators can control the video files or documents presented by assigning unique identifiers to a webpage or application page, or by allowing the content descriptors to be determined by the webpage's metadata, or by analyzing page content and using specific search algorithms to determine content descriptors.

### DESCRIPTION OF THE DRAWINGS

FIG. 1 is an illustration showing the overall architecture of the context-sensitive learning assets service.

FIG. 2 is an illustration of the service presenting a Client-Side Java Script Scenario of the service.

FIG. 3 is an illustration of the service presenting a Server-Side Component Scenario of the service.

FIG. 4 is a flow chart illustration of the service used in ‘static’ mode.

FIG. 5 is a flow chart illustration of the service used in dynamic metadata-driven mode.

FIG. 6 is a flow chart illustration of the service used in dynamic content-Driven Mode showing a ‘post-send analysis’.

FIG. 7 is a flow chart illustration of the service used in dynamic content-driven mode showing a ‘pre-send analysis’.

### DESCRIPTION OF THE PREFERRED EMBODIMENT(S)

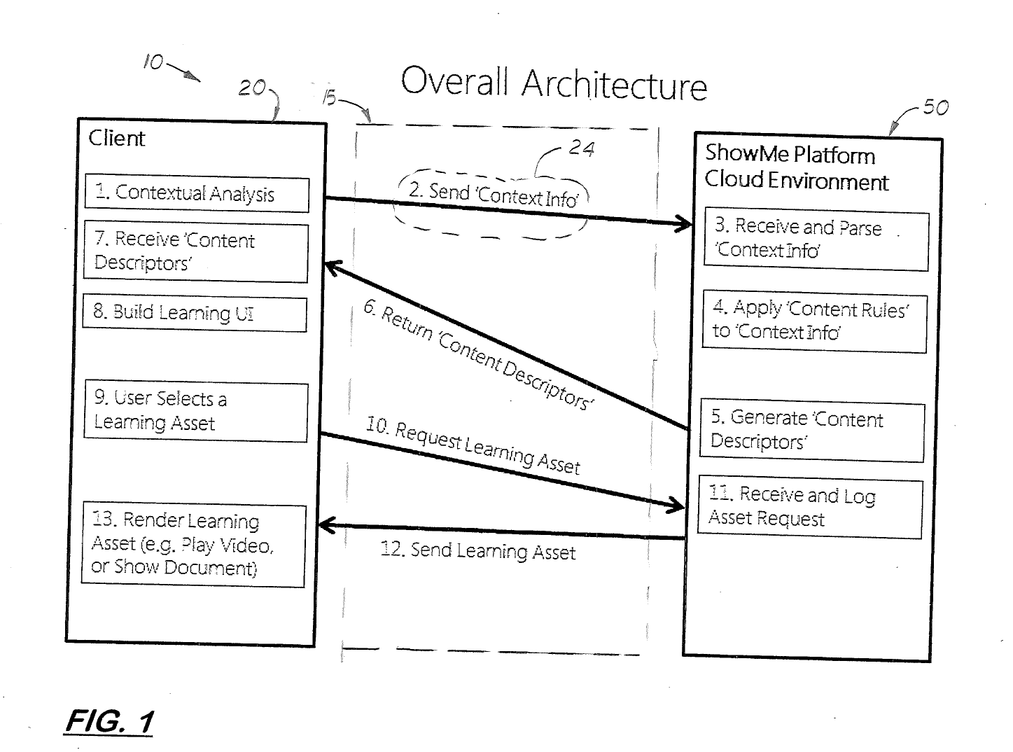

Referring to the accompanying FIGS. 1-7, there is shown a system and method of presenting context-sensitive learning assets, such as videos or other files, in an end user interface. During use, components in the user interface send context information to a learning platform, and the context information is used to identify content descriptors for the appropriate learning assets. The content descriptors are sent back to the user interface. Once returned to the user interface, the learning assets described by the content descriptors can be viewed by the end user. The system and method uses one of three modes for creating content descriptors. In a first mode, called a static mode, a unique identifier is sent from the user interface. Content descriptors identified by the unique identifier are returned to the user's interface and then used to access video files or documents from the library.

In a second mode, called a dynamic metadata-driven mode, metadata from the webpage being visited is first sent to the platform. Pre-established Rules associated with the metadata are then used to determine content descriptors, which are then sent to the end user interface. Like the static mode, the content descriptors are then used to access the video files or documents from the library.

In a third mode, called a dynamic content-driven mode, the entire website page being viewed is analyzed by the platform and specific search algorithms and filters are applied to create content descriptors, which are then returned to the end user interface. The content descriptors are then used to access the video files or documents from the library.

FIG. 1 is an illustration showing the overall architecture of the context-sensitive learning assets service 10 showing two main components—a client 20 and an asset presenter 50. The client 20 is a webpage or software application page that is linked to assets (i.e. video file or digital document) that are controlled by the asset presenter 50. When the client 20 makes initial contact with the asset presenter 50, the asset presenter 50 analyzes the current context (such as the current webpage, where the client 20 is in the application, what tasks the client 20 is attempting to perform, and the current page content, if applicable). The current context information, known as ‘Context Info’ and denoted by the reference number 24, is sent from the client 20 to the Asset presenter over the Internet 15.

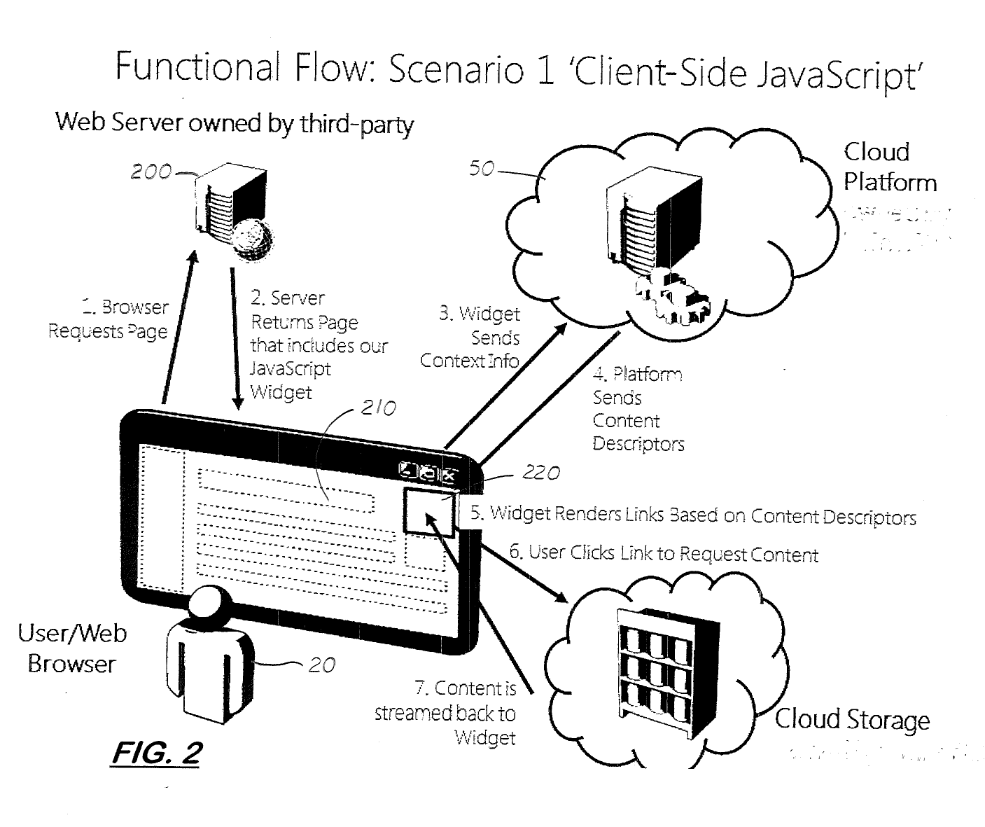

It is important to note, there are two scenarios—a client side scenario (also called a JavaScript scenario) and a server side scenario. FIG. 2 depicts the client side scenario, in which the client 20 uses a browser to request a webpage 210 from a server 200. The server 200 returns the webpage 210 that includes an embedded JavaScript widget 220 provided by the asset service 50. When a website 210 is visited, the widget 220 sends the ‘Context Info’ to the Asset presenter. The platform then sends the content descriptors to the user. The widget 220 then renders links based on the content descriptors within the client 20 which the user then clicks to request the content. The Asset presenter 50 then provides the content back to the widget 220.

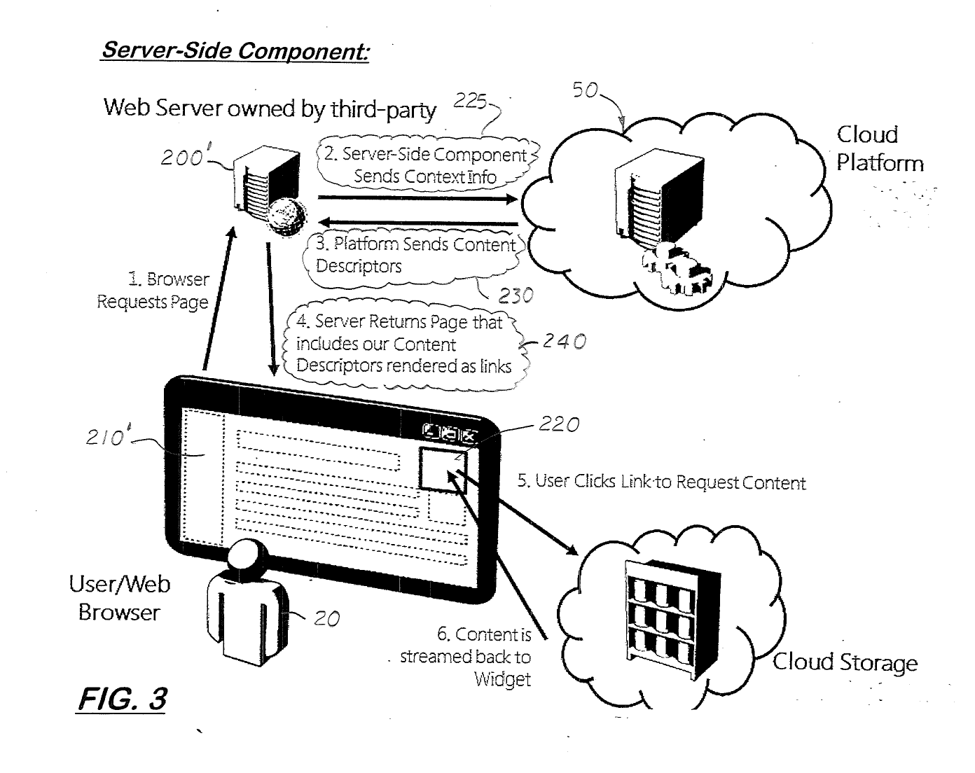

FIG. 3 is an illustration of the server side scenario in which a web server 200′ is owned by a third party. The client 20 uses a browser to request a webpage page 210′ from the web server 200′ which then sends context information to the asset presenter 50. The asset presenter 50 then sends context descriptors to the web server 200′. The web server 200′ then returns the requested page 240 that includes the Content descriptors rendered as links. The client 20 then clicks the links in the client 20 to request the Requested content which is then provided to the widget.220.

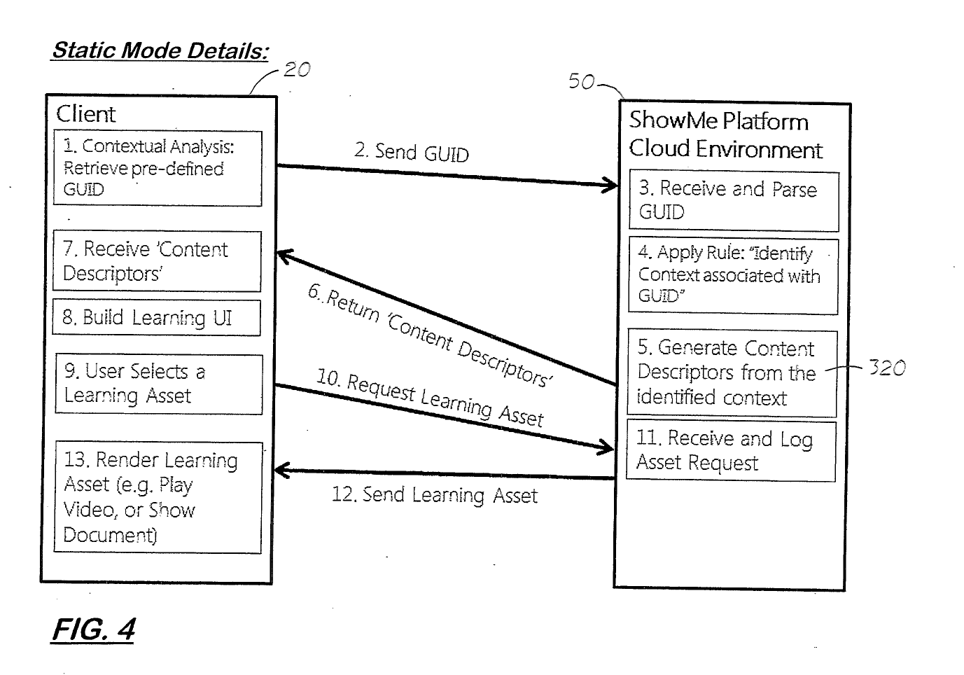

Referring to FIG. 4 which shows a Static mode, the asset presenter receives and parses the ‘Context Info’. The asset presenter 50 applies logic to the ‘Context Info’, hereinafter known as ‘Content Rules’. The result of applying ‘Content Rules’ is data called ‘Content Descriptors’ 320. The ‘Content Descriptors’ 320 are representations of the content deemed to be relevant to the client 20, based on the ‘Context Info’.

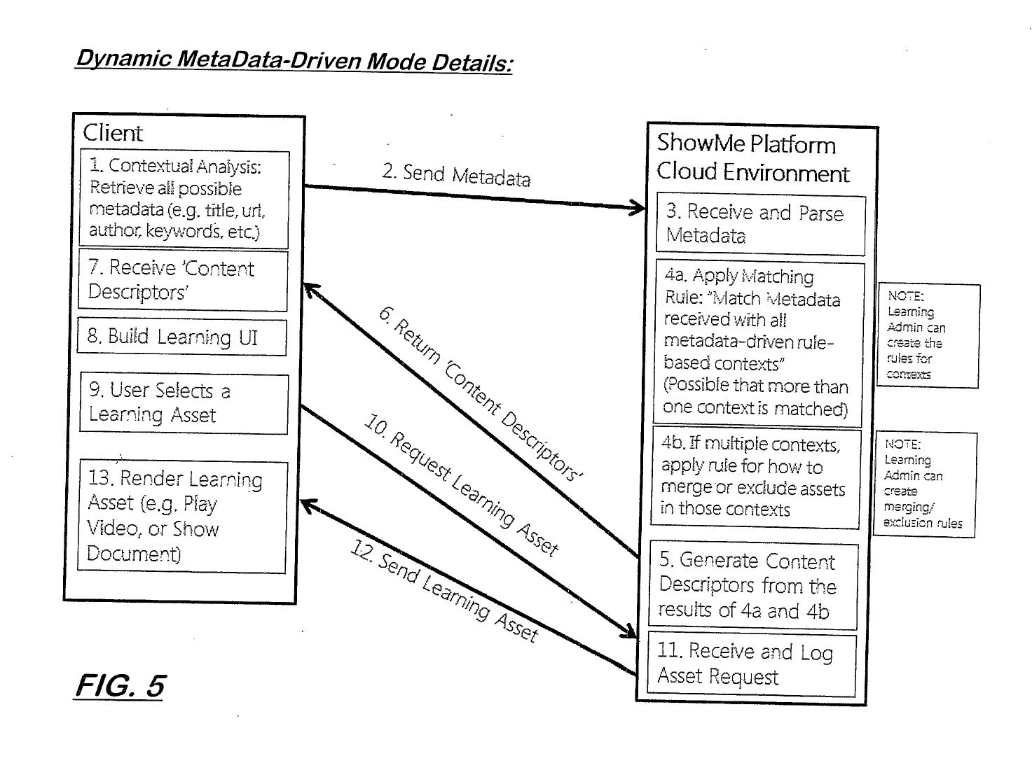

Referring to FIG. 5 which shows the dynamic metadata-driven mode, the asset presenter receives and parses the ‘context info’, which in this case consists of metadata collected from the client, such as Title and Keyword tags, URL, Date Modified, MIME-Type, etc.. The content rules for this dynamic metadata-driven mode consist of logic that identifies learning assets which have been associated with the metadata types and values

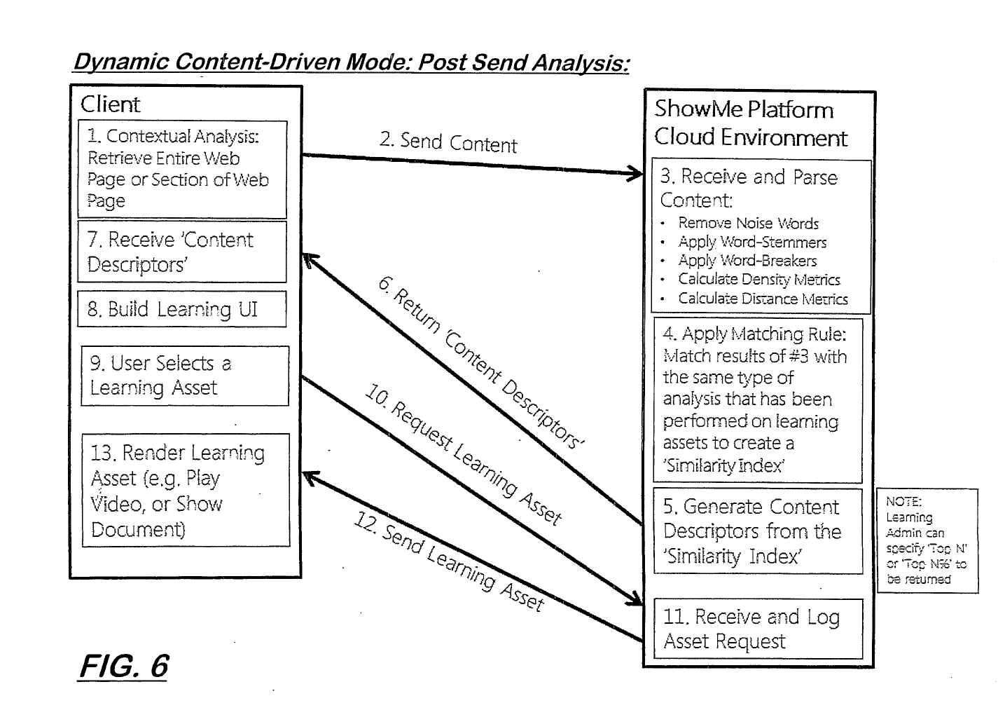

Referring to FIG. 6, which shows the dynamic content-driven mode using a post-send analysis, the entire contents of the page (or section of a page) are sent by the client, and the asset presenter performs content analysis. This content analysis processes the content to remove noise words (such as: the, and, it, he, she, they, etc.), breaks down the words into their base (stem) form, generates a mathematical histogram of the density of specific words, and generates a mathematical ‘distance’ map between the words. Then, the asset presenter applies content rules to compare the results of the content analysis with a similar analysis that the learning platform has performed on the learning assets. This comparison results in a similarity index which is then used to generate the content descriptors for the most relevant learning assets.

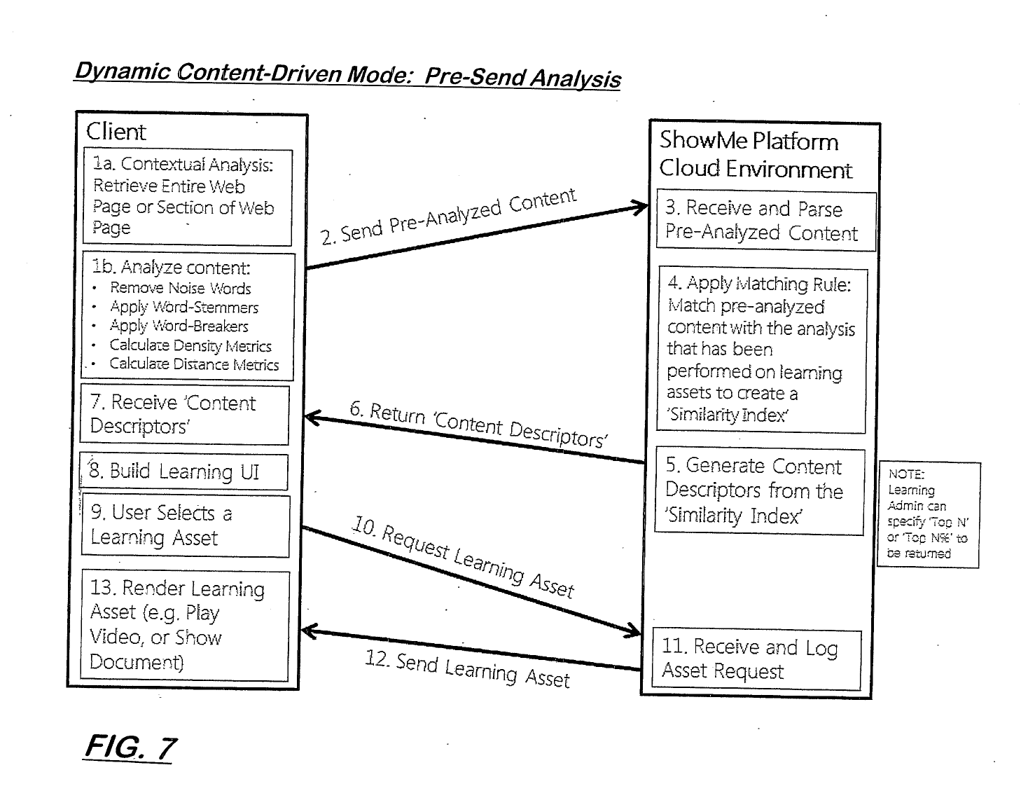

Referring to FIG. 7, which shows the dynamic content-driven mode using a pre-send analysis, controls in the client process the entire contents of the page (or section of a page) by removing noise words (such as: the, and, it, he, she, they, etc.), breaking down the words into their base (stem) form, generating a mathematical histogram of the density of specific words, and generating a mathematical ‘distance’ map between the words. The results of this content analysis are then sent by the client to the asset presenter. Then, the asset presenter applies content rules to compare the results of the content analysis sent from the client with a similar analysis that the learning platform has performed on the learning assets. This comparison results in a similarity index which is then used to generate the content descriptors for the most relevant learning assets.

In summary, a method of presenting context-sensitive learning assets, such as videos or other files, in a website or application is disclosed comprising the following steps:
a. adding controls to a webpage or application page;
b. transmitting context information and/or page content from those controls to the learning platform;
c. generating content descriptors on the learning platform, based on the information received from the controls;
d. transmitting those content descriptors back to the controls in the application;
e. rendering user interface components based on the received content descriptors; and,
f. retrieving and displaying learning assets described by the content descriptors in the user interface components.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

We claim:

1. A method of presenting context-sensitive learning assets, such as videos or other files, in a website or application, comprising:
a. adding controls to a webpage or application page;
b. transmitting context information from those controls to the learning platform;
c. generating content descriptors on the learning platform, based on the context information received from the controls;
d. transmitting those content descriptors back to the controls in the webpage or application;
e. rendering user interface components based on the received content descriptors; and,
f. retrieving and displaying learning assets described by the content descriptors in the user interface components.

2. The method as recited in claim 1, wherein the context information is a unique identifier.

3. The method as recited in claim 1, wherein the context information is page metadata, such as the page title, keyword tags, the page URL, the date modified, and the MIME-type.

4. The method as recited in claim 1, wherein the context information is generated by applying filtering and search algorithms to the page content.
